(19) United States
(12) Patent Application Publication
(10) Pub. No.: US 2022/0082908 A1
(43) Pub. Date: Mar. 17, 2022

(54) FOLDABLE HANDHELD GIMBAL

(71) Applicant: SZ DJI TECHNOLOGY CO., LTD., Shenzhen (CN)

(72) Inventor: Tianfei ZHAO, Shenzhen (CN)

(21) Appl. No.: 17/456,616

(22) Filed: Nov. 26, 2021

Related U.S. Application Data
(63) Continuation of application No. PCT/CN2019/088594, filed on May 27, 2019.

(51) Int. Cl. G03B 17/56; F16M 11/12

(52) U.S. Cl. CPC G03B 17/563; F16M 11/123; G03B 17/561

(57) ABSTRACT

A foldable handheld gimbal includes a handle, a first motor, a first connection bracket, a second motor, a second connection bracket, a third motor, a carrier structure, and a hinge structure. The first motor is arranged at the handle and configured to drive a load to rotate around a first motor shaft. The first connection bracket includes a first connection arm and a second connection arm. The second motor is connected to the second connection arm and configured to drive the load to rotate around a second motor shaft. An end of the second connection bracket is connected to the second motor. The third motor is connected to another end of the second connection bracket. The carrier structure is fixedly connected to a stator of the third motor and configured to carry the load. The hinge structure is hinged to the first motor and the first connection arm.

### CROSS-REFERENCE TO RELATED APPLICATION

This application is a continuation of International Application No. PCT/CN2019/088594, filed May 27, 2019, the entire content of which is incorporated herein by reference.

### TECHNICAL FIELD

The present disclosure generally relates to the gimbal technology field and, more particularly, to a foldable handheld gimbal.

### BACKGROUND

When a handheld photographing device such as a cell phone is used for shooting a video or image, a user body or arm shakes easily. Thus, a captured image will be shaken or blurred accordingly. Therefore, when the user uses the handheld photographing device for photographing, a handheld gimbal is usually used to fix the handheld photographing device, so as to adjust a photography angle of the photographing device and stably maintain the determined photography angle when the handheld camera is used for photography. However, the current handheld gimbal has a relatively large size, and the size is unchanged in a working state and a non-working state. Thus, the handheld gimbal is inconvenient to carry and store, which affects the user experience.

### SUMMARY

Embodiments of the present disclosure provide a foldable handheld gimbal, including a handle, a first motor, a first connection bracket, a second motor, a second connection bracket, a third motor, a carrier structure, and a hinge structure. The handle is in a rod shape. The first motor is arranged at the handle and configured to drive a load to rotate around a first motor shaft. The first connection bracket includes a first connection arm and a second connection arm that bends and extends along an end of the first connection arm toward a side facing away from the handle. The second motor is connected to the second connection arm and configured to drive the load to rotate around a second motor shaft. An end of the second connection bracket is connected to the second motor. The third motor is connected to another end of the second connection bracket and configured to drive the load to rotate around a third motor shaft. The carrier structure is fixedly connected to a stator of the third motor and configured to carry the load. The hinge structure is hinged to the first motor and the first connection arm. The first connection arm rotates around a hinge joint to switch the handheld gimbal from an operation state to a folded state. When the handheld gimbal is in the folded state, the second connection arm and the carrier structure are located on both sides of the handle, respectively.

### BRIEF DESCRIPTION OF THE DRAWINGS

FIG. 1 is a schematic structural diagram of a handheld gimbal with a carrier structure for carrying a load according to some embodiments of the present disclosure.

FIG. 2 is a schematic structural diagram of the handheld gimbal in FIG. 1 with the carrier structure carrying no load.

FIG. 3 is a schematic structural diagram of the gimbal in FIG. 2 viewing from another angle.

FIG. 4 is a partially enlarged schematic diagram showing part A of the handheld gimbal in FIG. 3.

FIG. 5 is a schematic structural diagram of the handheld gimbal in FIG. 2 with a first connection bracket being folded about a hinge connection.

FIG. 6 is a schematic structural diagram of the handheld gimbal in FIG. 5 viewing from another angle.

FIG. 7 is a schematic structural diagram of the handheld gimbal in FIG. 2 in a folded state.

FIG. 8 is a schematic structural diagram of the handheld gimbal in FIG. 7 viewing from another angle.

FIG. 9 is a schematic partial structural diagram of the handheld gimbal in FIG. 2, including a handle, a first motor, and a first hinge member.

FIG. 10 is a schematic partial structural diagram of the handheld gimbal in FIG. 2, including a hinge member, a first connection bracket, a second motor, a second connection bracket, a second hinge structure, a third motor, and a carrier structure.

FIG. 11 is a schematic partial cross-sectional diagram showing a handheld gimbal, including a first rotation shaft assembly, a first hinge member, a second hinge member, and a first connection bracket, according to some embodiments of the present disclosure.

FIG. 12 is a schematic structural diagram showing a first lock member of the handheld gimbal in FIG. 11.

FIG. 13 is a schematic structural diagram showing a second lock member of the handheld gimbal in FIG. 11.

FIG. 14 is a schematic structural diagram of a handheld gimbal, including a handle, a first motor, a first hinge member, a first rotation shaft assembly, a second hinge member, and a first connection bracket, according to some embodiments of the present disclosure.

FIG. 15 is a schematic partial cross-sectional diagram of a handheld gimbal, including a first lock mechanism, a first hinge member, and a second hinge member, according to some embodiments of the present disclosure.

### REFERENCE NUMERALS

100 Handheld gimbal, 110 Handle, 111 Handle body, 112 First plane member, 113 Second plane member, 114 Sidewall, 121 First motor, 122 Second motor, 123 Third motor, 130 First connection bracket, 131 First connection arm, 132 Second connection arm, 140 Second connection bracket, 141 Third connection arm, 142 Fourth connection arm, 150 Carrier structure; 160 First hinge structure, 161 First hinge member, 1611 First connection hole, 162 Second hinge member, 1621 Second connection hole, 163 First rotation shaft assembly, 1631 First lock mechanism, 16311 First position limit hole, 16312 Second elastic member, 16313 Second position limit hole, 16314 Positioning member, 1632 First rotation shaft, 1633 First lock member, 1634 Second lock member, 1635 Protrusion structure, 16351 Highest protrusion point, 16352 Lowest protrusion point, 1636 Recessed structure, 16361 Lowest recess point, 1637 First elastic member;

170 Second hinge structure, 171 Third hinge member, 172 Fourth hinge member, 173 Second rotation shaft assembly, 180 Control assembly, 181 Operation member; 200 Load, 300 Cell phone, Y First motor shaft, P Second motor shaft, R Third motor shaft.

### DETAILED DESCRIPTION OF THE EMBODIMENTS

Embodiments of the present disclosure are described in detail below. Examples of embodiments of the present disclosure are shown in the accompanying drawings. Same or similar reference numerals indicate the same or similar elements or elements with same or similar functions. Embodiments of the present disclosure described referring to the drawings are exemplary and only used to explain the present disclosure and cannot be understood as a limitation to the present disclosure.

In the description of embodiments of the present disclosure, orientational or positional relationship indicated by terms such as “center,” “longitudinal,” “landscape,” “length,” “width,” “thickness,” “upper,” “lower,” “front,” “back,” “left,” “right,” “vertical,” “horizontal,” “top,” “bottom,” “inner,” “outer,” “clockwise,” “counterclockwise” are based on the orientational or positional relationship shown in the drawings. The terms are only used to facilitate the description of embodiments the present disclosure and simplify the description, rather than indicating or implying that the device or element referred to must have a specific orientation and be constructed and operated in a specific orientation. Therefore, the terms cannot be understood as a limitation to the present disclosure. In addition, the terms “first” and “second” are only used for descriptive purposes and cannot be understood as indicating or implying relative importance or implicitly indicating the number of indicated technical features. Thus, a feature as associated with “first” and “second” may explicitly or implicitly include one or more of the features. In the description of the present disclosure, “a plurality of” means two or more than two, unless otherwise specifically defined.

A handheld gimbal 100 of embodiments of the present disclosure includes a handle 110 and a stabilization gimbal mechanism connected to the handle 110. The stabilization gimbal mechanism includes a first motor 121, a second motor 122, a third motor 123, a connection bracket, and a hinge structure. The stabilization gimbal mechanism may not only be detachably connected to the handle 110, but also may be detachably connected to another carrier, such as an unmanned aerial vehicle (UAV), a vehicle, a ground remote control carrier, etc. The stabilization gimbal mechanism may be quickly connected to the carrier, so that the stabilization gimbal mechanism may be switched between different carriers. For example, the stabilization gimbal mechanism may be switched between the UAV and the handle 110 or the stabilized gimbal may be switched between the ground remote control carrier and the handle 110.

The handheld gimbal 100 of embodiments of the present disclosure has a folding function and may be switched between an unfolded operation state and a folded storage state. When the handheld gimbal is switched from the operation state to the storage state, motors may be directly switched from a power-on mode to a power-off mode. On the contrary, when the handheld gimbal is switched from the storage state to the unfolded state, the motors may be switched from the power-off mode to the power-on mode for direct use. For example, when the handheld gimbal is switched from the operation state to the storage state, two connection brackets may rotate relative to each other. When an angle between extension directions of the two connection brackets is less than a certain angle, at least one of the first motor 121, the second motor 122, or the three motors 123 may be switched from the power-on mode to the power-off mode.

The angle between the extension directions of the two connection brackets may be smaller than a certain angle, which may be 90°, 80°, 70°, or 45° and is not specifically limited here.

When at least one of the first motor 121, the second motor 122, or the third motor 123 is switched from the power-on mode to the power-off mode, following situations may be included. Only the first motor 121, only the second motor 122, or only the third motor 123 may be switched from the power-on mode to the power-off mode. In some embodiments, two of the motors may be switched from the power-on mode to the power-off mode, for example, the first motor 121 and the second motor 122, the first motor 121 and the third motor 122, or the second motor 122 and the third motor 123. In some other embodiments, all three motors may switched from the power-on mode to the power-off mode.

Therefore, when the handheld gimbal is switched from the unfolded operation state to the folded storage state, one or more of the motors may be directly switched from the power-on mode to the power-off mode. In some other embodiments, when the handheld gimbal is switched from the folded storage state to the unfolded operation state, one or more of the motors may be directly switched from the power-off mode to the power-on mode. As such, the battery power of the handheld gimbal may be saved, and the handheld gimbal may be operated conveniently.

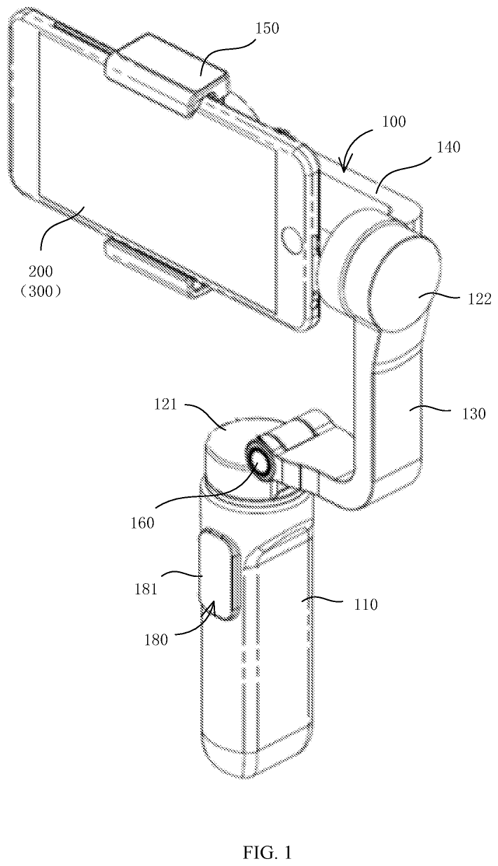

Referring to FIGS. 1 to 8, the foldable handheld gimbal 100 of embodiments of the present disclosure is configured to carry a load 200 to adjust the position and orientation of the load 200 to meet operation requirements of various scenarios. In some embodiments, the handheld gimbal 100 may also compensate for vibration borne by the load 200 through rotation to stably balance the load 200. Thus, the load 200 may work in a better attitude to obtain more accurate information.

The load 200 may include one of an imaging device, a mobile terminal, a sensor, etc. The imaging device may include an image acquisition device such as a video camera, a camera, an ultrasonic imaging device, an infrared imaging device, and an imaging lens. The mobile terminal may include a cell phone, a tablet computer, etc. The sensor may include an attitude sensor, such as an angle sensor, an acceleration sensor, etc. The imaging device may also include some mobile terminals. For example, the imaging device may include the cell phone, the tablet computer, etc. with video recording and photographing functions. The mobile terminal may also include some imaging devices.

Referring again to FIG. 1, in some embodiments of the present disclosure, a cell phone 300 with video recording and photographing functions is used as an example for description. The user may perform photographing by using the handheld gimbal to carry the cell phone 300. The handheld gimbal may stabilize the mobile phone 300 or control the attitude of the cell phone 300.

Referring again to FIGS.1 to 8, in some embodiments, the handheld gimbal 100 includes a handle 110, a first motor 121, a first connection bracket 130, a second motor 122, a second connection bracket 140, a third motor 123, a carrier structure 150, and a first hinge structure 160.

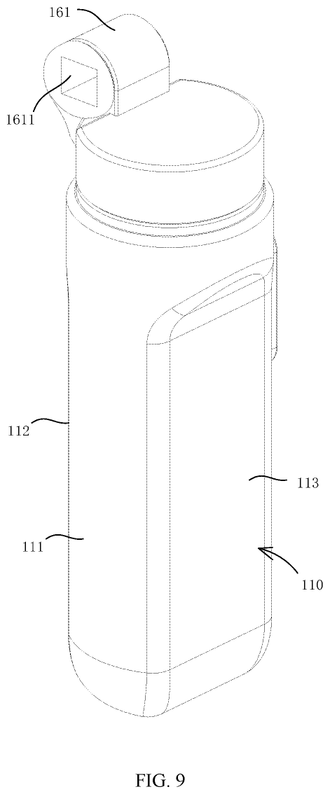

Referring to FIG. 9, the handle 110 is approximately in a vertical rod shape and is configured for the user to hold and manipulate the handheld gimbal 100. In some embodiments, the handle 110 includes a handle body 111, a first plane member 112, and a second plane member 113. The handle body 111 is connected to the first motor 121. The first plane member 112 is arranged on a side of the handle body 111. The second plane member 113 and the first plane member 112 are arranged on two opposite sides of the handle body 111.

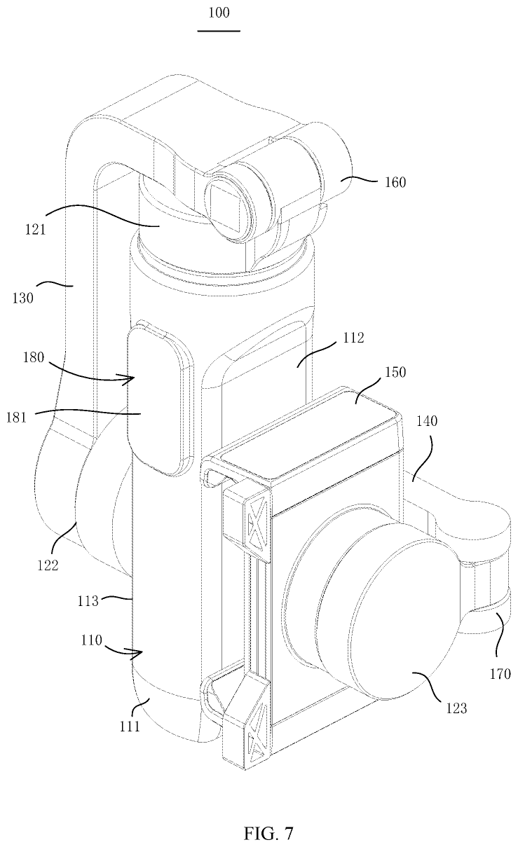

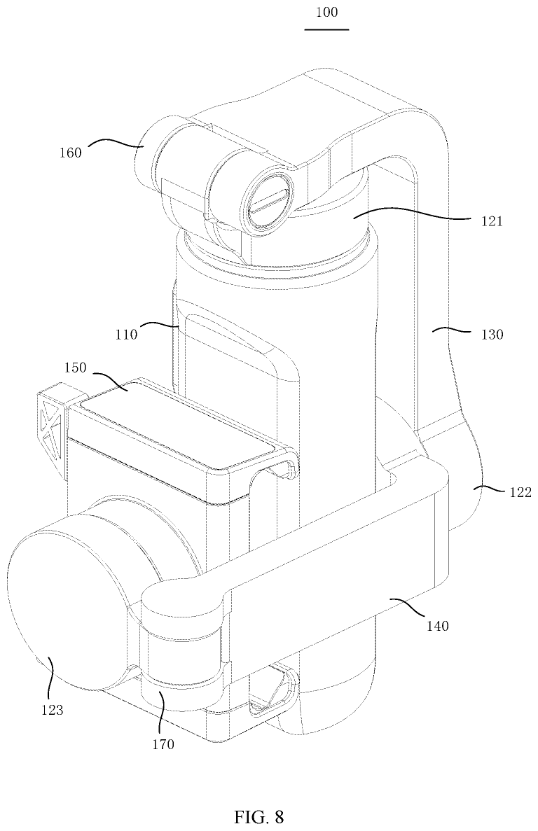

Referring to FIGS. 7 and 8, when the handheld gimbal 100 is in the folded state, the cross sections of the first plane member 112 and the third motor 123 are approximately parallel to each other. The cross sections of the second plane member 113 and the second motor 122 are approximately parallel to each other. In this disclosure, two items being “approximately parallel” to each other means that the angle between the two items may be from 0° to 10°, such as 0°, 10°, or any angle between 0° to 10°.

In some embodiments, the first plane member 112 and the second plane member 113 may be approximately parallel, which is convenient for the user to hold. When the handheld gimbal 100 is folded, the handle 110 may be facilitated to adapt to the shape of the second motor 122 and the third motor 123 after the handheld gimbal 100 is folded to reduce the volume of the handheld gimbal 100.

Referring to FIGS. 1 to 10, in some embodiments, the first connection bracket 130 includes a first connection arm 131 and a second connection arm 132. One end of the first connection arm 131 is connected to the first motor 121. The second connection arm 132 is bent relative to the first connection arm 131 and extends from the other end of the first connection arm 131 that is away from the handle 110. An end of the second connection arm 132 away from the first connection arm 131 is connected to the second motor 122.

In some embodiments, the first motor 121 may include a connection portion (not labeled) connected to the first connection arm 131. The first connection arm 131 and the connection portion of the first motor 121 may include an integral structure. As such, a quantity of components may be reduced to facilitate assembly and improve production efficiency of the handheld gimbal 100. In some embodiments, the first connection arm 131 and the connection portion of the first motor 121 may be integrally formed by an injection molding process. In some other embodiments, the first connection arm 131 and the connection portion of the first motor 121 may also be formed separately. Similarly, the second motor 122 may include a connection portion (not labeled) connected to the second connection arm 132. The second connection arm 132 and the connection portion of the second motor 122 may include an integral structure or may be formed separately.

The angle between the first connection arm 131 and the second connection arm 132 may be set to any suitable angle. For example, the angle between the first connection arm 131 and the second connection arm 132 may be approximately 90°. That is, the first connection arm 131 may be approximately perpendicular to the second connection arm 132. The first connection arm 131 and the second connection arm 132 may approximately form an L-shaped structure.

The length of the first connection arm 131 may be shorter than the length of the second connection arm 132. The length of the second connection arm 132 may be shorter than the length of the handle 110. As such, when the handheld gimbal 100 is in the folded state, the first connection bracket 130 may be overlapped with the handle 110 to reduce the size of the handheld gimbal 100.

Referring to FIGS. 1 to 9, in some embodiments, the first connection arm 131 and the first motor 121 are hinged through the first hinge structure 160. The first connection arm 131 may rotate around the hinge joint to cause the handheld gimbal 100 to be switched from the operation state to the folded state. The second connection arm 132 and the carrier structure 150 are located on two sides of the handle 110, respectively.

Referring again to FIGS. 1 to 8, in some embodiments, the first motor 121 is arranged at the handle 110. One end of the first connection bracket 130 is connected to the first motor 121. The second motor 122 is connected to the other end of the first connection bracket 130. One end of the second connection bracket 140 is connected to the second motor 122. The third motor 123 is connected to the other end of the second connection bracket 140. The first motor 121 and the first connection bracket 130 are hinged through the first hinge structure 160. The second connection bracket 140 and the third motor 123 are hinged through the second hinge structure 170. As such, when the handheld gimbal 100 is not in use, the first connection bracket 130 and the third motor 123 may be rotated around the hinge joint to cause the second motor 122 and the third motor 123 to be located on opposite sides of the handle 110, respectively. Thus, the handheld gimbal 100 may be in the folded state. The overall volume of the handheld gimbal 100 may be reduced. The handheld gimbal 100 may occupy a small space to facilitate the user to store and carry. Thus, the user experience may be improved.

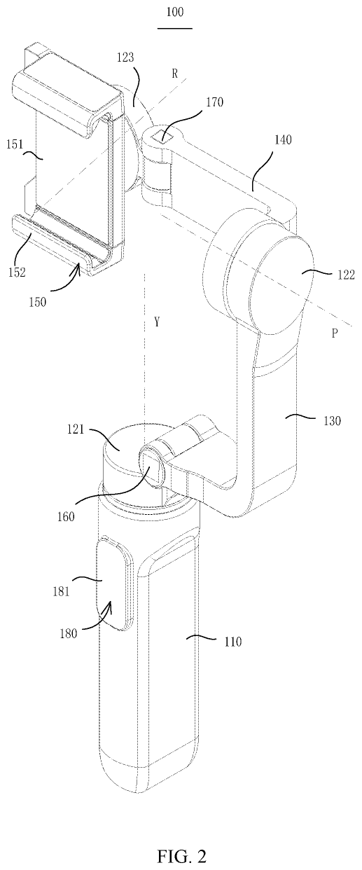

Referring to FIGS. 1 and 2, the first motor 121 is configured to drive the load 200 to rotate along a first motor shaft Y. In some embodiments, the handle 110 and the first connection bracket 130 are both connected to the first motor 121. One end of the first connection bracket 130 is connected to the first motor 121. The other end of the first connection bracket 130 is connected to the second motor 122. In some embodiments, the handle 110 may be connected to a stator of the first motor 121. The first connection bracket 130 may be connected to a rotor of the first motor 121. The rotor of the first motor 121 may rotate around the first motor shaft Y relative to the stator of the first motor 121. Further, the rotor of the first motor 121 may drive the first connection bracket 130, the second motor 122, the second connection bracket 140, the third motor 123, and the load 200 to rotate around the first motor shaft Y of the handheld gimbal 100.

Referring again to FIGS. 1 to 8, the second motor 122 is configured to drive the load 200 to rotate around the second motor shaft P. In some embodiments, one end of the second motor 122 is connected to the first connection bracket 130, and the other end of the second motor 122 is connected to the second connection bracket 140. The end of the second connection bracket 140 away from the second motor 122 is connected to the third motor 123. In some embodiments, the first connection bracket 130 is connected to the stator of the second motor 122. The second connection bracket 140 is connected to the rotor of the second motor 122. The rotor of the second motor 122 may rotate relative to the stator of the second motor 122. Further, the rotor of the second motor 122 may drive the second connection bracket 140, the third motor 123, and the load 200 to rotate around the second motor shaft P of the handheld gimbal 100.

Referring to FIGS. 1 and 2, the third motor 123 is configured to drive the load 200 to rotate around the third motor shaft R. One end of the third motor 123 is connected to the second connection bracket 140. The other end of the third motor 123 is directly connected to the carrier structure 150 configured to arrange and fix the load 200. The carrier structure 150 may be fixedly connected to the rotor of the third motor 123. In some embodiments, the second connection bracket 140 may be connected to the stator of the third motor 123. The carrier structure 150 may be connected to the rotor of the third motor 123. When the rotor of the third motor 123 rotates relative to the stator of the third motor 123, the carrier structure 150 and the load 200 may be rotated around the third motor shaft R of the handheld gimbal 100.

Referring again to FIGS. 1 to 8, in some embodiments, the carrier structure 150 is configured to carry a mobile terminal with a photographing function, such as a cell phone 300. The carrier structure 150 may include a clamping structure. In some embodiments, the carrier 150 includes a main body 151 and a clamping member 152. The main body 151 may be connected to the rotor of the third motor 123. The main body 151 is configured to at least partially abut against the cell phone 300. The clamping member 152 is configured to fix the cell phone 300 on the main body 151. To facilitate the arrangement of cell phones 300 of different sizes, the clamping size of the clamping member 152 may be adjusted as needed. For example, the clamping member 152 may include two oppositely arranged movable jaws to cooperate and clamp the cell phone 300. The clamping member 152 may be configured to adjust the clamping size through cooperation of a gear and a rack. In some embodiments, the carrier structure 150 may further include sliding grooves (not labeled) arranged oppositely. Thus, the cell phone 300 may be easily mounted to the carrier structure 150 via the sliding grooves.

In some other embodiments, the carrier structure 150 may include an imaging device, for example, an imaging lens, a camera with a lens, etc. In some embodiments, the imaging lens is taken as an example for description. In some embodiments, the carrier structure 150 may include a movable member and a fixed member. The movable member may be rotatably connected to the fixed member. Thus, the movable member may be closed to or separated from the fixed member. A lock member such as a lock structure may be configured to close or separate of the movable member and the fixed member. The shapes of the movable member and the fixed member may adapt to the imaging lens. When the movable member and the fixed member are closed, the imaging lens may be clamped and fixed on the handheld gimbal 100. When the imaging lens needs to be detached, the lock member may be operated to separate the movable member from the fixed member to release the imaging lens to facilitate the detachment of the lens from the handheld gimbal 100. Further, the imaging lens may include a square lens, a circular lens, an irregular shape lens, etc. In addition, the size and model of the imaging lens may also be selected according to user needs, which is not limited here.

A cooperation structure of the load 200 and the third motor 123 may not be limited to the structure shown above and may also include any suitable quick-release structure, as long as the load 200 can be quickly mounted and locked at the third motor 123 and can be quickly unlocked and separated from the third motor 123.

The load 200 may swing around the first motor shaft Y, the second motor shaft P, and the third motor shaft R. Thus, the handheld gimbal 100 may stabilize the load 200 or control the attitude of the load 200 in three different shaft directions to cause the load 200 to be maintained in a better and longer work state.

Referring to FIGS. 1 and 2, in some embodiments of the present disclosure, the first motor 121 is a yaw motor, and correspondingly, the first motor shaft Y is a yaw motor shaft. The second motor 122 is a pitch motor, and correspondingly, the second motor shaft P is a pitch motor shaft. The third motor 123 is a roll motor, and correspondingly, the third motor shaft R is a roll motor shaft.

In some embodiments, any two of the first motor shaft Y, the second motor shaft P, and the third motor shaft R may be approximately perpendicular to each other. Two items being “approximately perpendicular” to each other may mean that the angle between the two items may be from 85° to 95°. In some other embodiments, the first motor shaft Y, the second motor shaft P, and the third motor shaft R may be arranged to any other suitable arrangement according to actual application scenarios. For example, at least two of the first motor shaft Y, the second motor shaft Y, and the second motor shaft may be non-orthogonal to each other.

In some embodiments, the first motor 121 may be configured to control the attitude of the load 200 in the yaw direction. The second motor 122 may be configured to control the attitude of the load 200 in the pitch direction. The third motor 123 may be configured to control the attitude of the load 200 in the roll direction. Thus, the handheld gimbal 100 may stabilize the load 200 in at three shafts and control the attitude of the load 200 to maintain the load 200 at a better attitude.

The first motor shaft Y, the second motor shaft P, and the third motor shaft R are all actual rotation shafts of the handheld gimbal 100. The dotted lines shown in FIG. 2 are axes of the first motor shaft Y, the second motor shaft P, and the third motor shaft R.

Referring again to FIGS. 1 to 8, in embodiments of the present disclosure, the first hinge structure 160 is hinged to the first motor 121 and the first connection bracket 130. The first hinge structure 160 may make the first connection bracket 130 rotate relative to the first motor 121 between the unfolded state and the folded state. Another intermediate state may be set between the folded state and the unfolded state for application needs. In some embodiments, a rotation angle of the first connection bracket 130 around the hinge joint may be designed according to actual needs. In some embodiments, the rotation angle of the first connection bracket 130 around the hinge joint may be from 135° to 215°. In some embodiments, the rotation angle of the first connection bracket 130 may be 180°. In some other embodiments, the rotation angle of the first connection bracket 130 may also be 135°, 215°, or any other suitable angle between 135° and 215°.

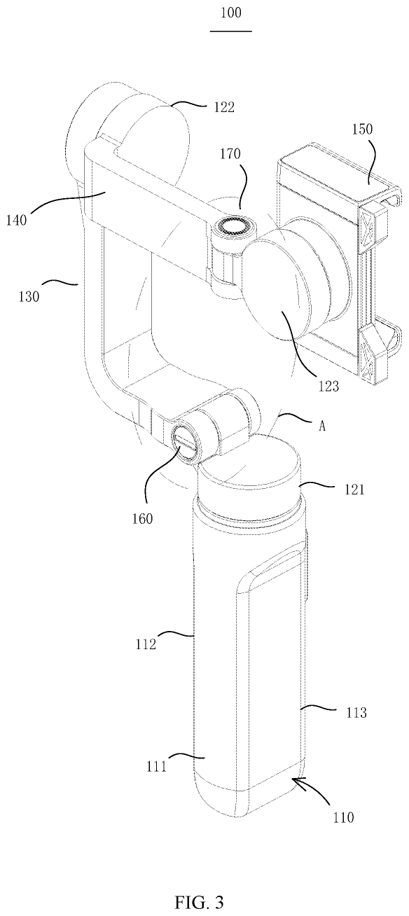

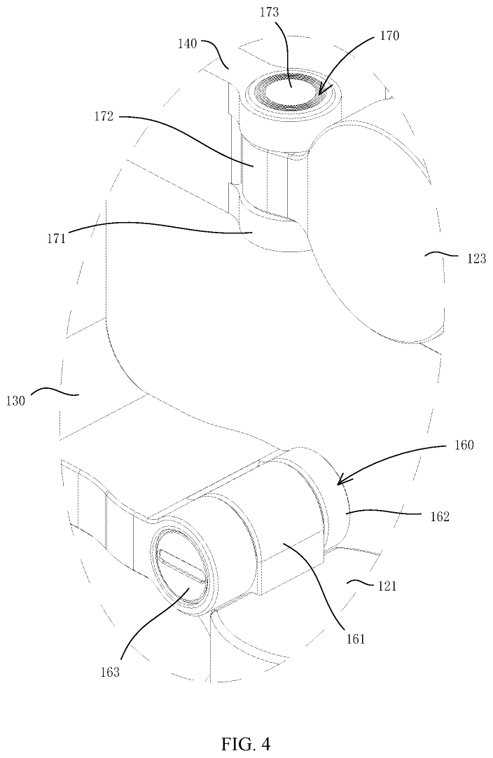

Referring to FIGS. 3 and 4, the first hinge structure 160 includes a first hinge member 161, a second hinge member 162, and a first rotation shaft assembly 163. The first hinge member 161 extends outward from the outer periphery of the first motor 121. The second hinge member 162 extends from the first connection bracket 130 toward one end of the first motor 121. The first rotation shaft assembly 163 is connected to the first hinge member 161 and the second hinge member 162 and configured to hinge the first motor 121 and the first connection bracket 130.

The first hinge member 161 and the second hinge member 162 may be arranged at any suitable position of the first rotation shaft assembly 163, as long as the first hinge member 161, the second hinge member 162, and the first rotation shaft assembly 163 may cooperate to realize the hinge connection of the first motor 121 and the first connection bracket 130. For example, the first hinge member 161 may be located at the end of the first rotation shaft assembly 163, and the second hinge member 162 may be located at the middle of the first rotation shaft assembly 163. As another example, the first hinge member 161 may be located at the middle of the first rotation shaft assembly 163, and the second hinge member 162 may be located at the end of the first rotation shaft assembly 163. As another example, the first hinge member 161 may be located at one end of the first rotation shaft assembly 163, and the second hinge member 162 may be located at the other end of the first rotation shaft assembly 163.

Any suitable number of the first hinge member 161 and the second hinge member 162 may be set according to actual needs. For example, the number of the first hinge member 161 may be one, the number of the second hinge member 162 may be two. The two second hinge members may extend along the same end of the first connection bracket 130 at an interval. The two second hinge members 162 may be arranged at two ends of the first rotation shaft assembly 163, respectively. The first hinge member 161 may be arranged at or near the middle of the first rotation shaft assembly 163.

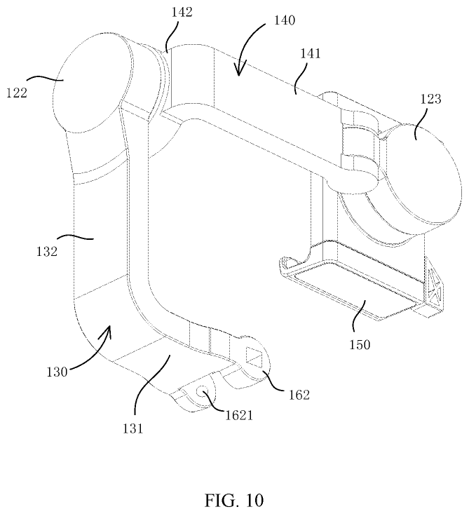

Referring to FIGS. 9 and 10, the first hinge member 161 includes a first connection hole 1611 along the axial direction of the first rotation shaft assembly 163. The second hinge member 162 includes a second connection hole 1621 along the axial direction of the first rotation shaft assembly 163. The second connection hole 1621 is matched with the first connection hole 1611. The first rotation shaft assembly 163 is arranged through the first connection hole 1611 and the second connection hole 1621 to hinge the first hinge member 161 and the second hinge member 162 to realize the hinge connection of the first motor 121 and the first connection bracket 130. The shapes of the first connection hole 1611 and the second connection hole 1621 may be designed to be any suitable shape, for example, a square hole, a round hole, another regular-shaped hole or irregular-shaped hole, etc., as long as the holes may adapt to the first rotation shaft assembly 163 and realize the hinge connection of the first motor 121 and the first connection bracket 130.

Referring to FIGS. 1 to 3, when the handheld gimbal 100 is in the unfolded state, projections of the first motor 121, the first hinge member 161, and the second motor 122 on the longitudinal cross-section of the handle 110 are arranged in sequence. That is, the first hinge portion 161 is arranged above the first motor 121. In some embodiments, the first hinge member 161 is substantially arranged above the periphery of the first motor 121 to facilitate the first connection bracket 130 to be switched between the unfolded state and the folded state relative to the first motor 121.

Referring again to FIGS. 1 to 8, in embodiments of the present disclosure, the handheld gimbal 100 further includes a second hinge structure 170 hinged between the second connection bracket 140 and the third motor 123. The second hinge structure 170 may cause the third motor 123 to rotate between the unfolded state and the folded state relative to the second connection bracket 140. Another intermediate state may be set between the folded state and the unfolded state for application needs. The rotation angle of the third motor 123 around the hinge joint may be designed according to actual needs. In some embodiments, the rotation angle of the third motor 123 around the hinge joint may be from 60° to 120°. In some embodiments, the rotation angle of the third motor 123 may be 90°. In some other embodiments, the rotation angle of the third motor 123 may also be 60°, 120°, or any other suitable angle between 60° and 120°.

Referring to FIG. 4, in some embodiments, the second hinge structure 170 includes a third hinge member 171, a fourth hinge member 172, and a second rotation shaft assembly 173. The third hinge member 171 extends from an end of the second connection bracket 140 that faces away from the second motor 122. The fourth hinge member 172 extends outward from the outer periphery of the third motor 123. The second rotation shaft assembly 173 is connected to the third hinge member 171 and the fourth hinge member 172 and configured to connect the second connection bracket 140 and the third motor 123.

The fourth hinge member 172 may extend outward from any suitable position on the outer periphery of the third motor 123 as long as the fourth hinge member 172 can be hinged to and matched with the third hinge member 171 and the second rotation shaft assembly 173. In some embodiments, the fourth hinge member 172 may extend outward from the side periphery of the third motor 123, and the fourth hinge member 172 may correspond to the position of the third hinge member 171 at the second connection bracket 140.

The third hinge member 171 and the fourth hinge member 172 may be arranged at any suitable position of the second rotation shaft assembly 173, as long as the third hinge member 171, the fourth hinge member 172, and the second rotation shaft assembly 173 may cooperate to realize the hinge connection of the he second connection bracket 140 and the third motor 123. For example, the third hinge member 171 may be located at the end of the second rotation shaft assembly 173, and the fourth hinge member 172 may be located at the middle of the second rotation shaft assembly 173. As another example, the third hinge member 171 may be located at the middle of the second rotation shaft assembly 173, and the fourth hinge member 172 may be located at the end of the second rotation shaft assembly 173. As another example, the third hinge member 171 may be located at one end of the second rotation shaft assembly 173, and the fourth hinge member 172 may be located at the other end of the second rotation shaft assembly 173.

The structure of the second rotation shaft assembly 173 may include any suitable structure, as long as the third hinge member 171, the fourth hinge member 172, and the second rotation shaft assembly 173 may cooperate to realize the hinge connection of the second connection bracket 140 and the third motor 123. In some embodiments, the structure of the second rotation shaft assembly 173 may be approximately the same as the structure of the first rotation shaft assembly 163.

Referring again to FIGS. 1 to 8 and 10, the second connection bracket 140 includes a third connection arm 141. One end of the third connection arm 141 is connected to the second motor 122 and the other end of the third connection arm 141 is connected to the third motor 123. The shape of the third connection arm 141 may include any suitable shape, such as a long strip shape.

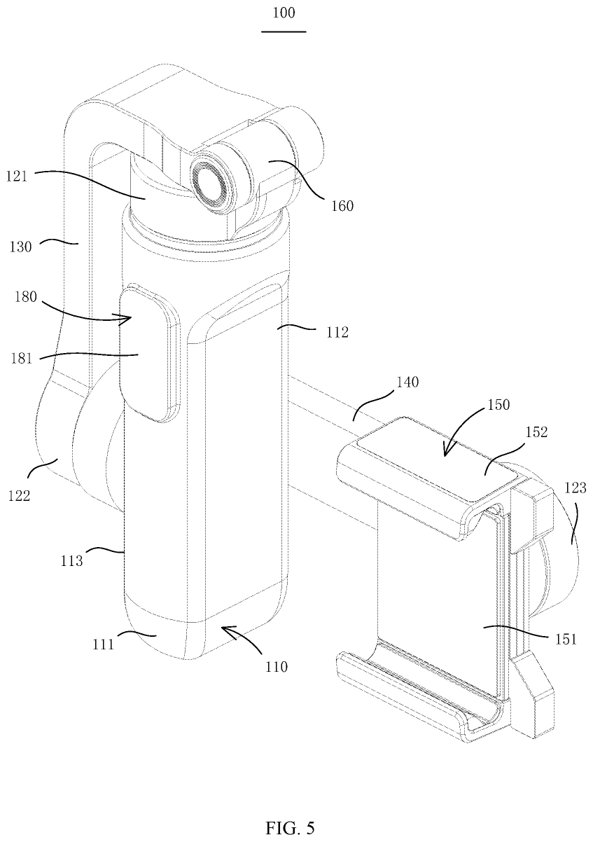

Referring to FIGS. 5 to 9, in some embodiments, the second connection bracket 140 further includes a fourth connection arm 142. Thus, when the first connection bracket 130 is folded along the hinge, the second connection bracket 140 may include a position avoidance space for avoiding the handle 110. The fourth connection arm 142 is connected between the second motor 122 and the third connection arm 141. In some embodiments, the third connection arm 141 is bended and extends along an end of the fourth connection arm 142 that faces away from the second motor 122. An end of the fourth connection arm 142 facing away from the third connection arm 141 is connected to the second motor 122. The fourth connection arm 142 may extend from any suitable position of the second motor 122. In some embodiments, the fourth connection arm 142 may extend from the side periphery of the second motor 122.

The angle between the third connection arm 141 and the fourth connection arm 142 may include any suitable angle. For example, the angle between the third connection arm 141 and the fourth connection arm 142 may be approximately 90°. That is, the third connection arm 141 may be approximately perpendicular to the fourth connection arm 142. The third connection arm 141 and the fourth connection arm 142 may approximately form an L-shaped structure. In some embodiments, the length of the third connection arm 141 may be shorter than the length of the fourth connection arm 142.

Referring to FIGS. 7 and 8, in some embodiments, a distance between an end surface of the third motor 123 facing the carrier structure 150 and the second plane member 113 is a. The length of the third connection arm 141 is greater than or equal to the distance a. As such, when the handheld gimbal 100 does not need to be used, the third motor 123 may be folded to a proper position around the hinge joint. Thus, when the handheld gimbal 100 is in the folded state, a clamping width direction of the carrier structure 150 may be approximately parallel to an extension direction of the handle 110.

Referring to FIGS. 7 and 8, a length extension direction of the fourth connection arm 142 is approximately perpendicular to a length extension direction of the first connection arm 131. The length extension direction of the fourth connection arm 142 is approximately perpendicular to the length extension direction of the second connection arm 132. A width extension direction of the fourth connection arm 142 is approximately perpendicular to a width extension direction of the second connection arm 132. The first connection arm 131, the third connection arm 141, and the fourth connection arm 142 are located on a same side of the second connection arm 132. The length extension direction of the third connection arm 141 is approximately parallel to the length extension direction of the first connection arm 131. The length extension direction of the third connection arm 141 is approximately perpendicular to the length extension direction of the second connection arm 132. The width extension direction of the third connection arm 141 is approximately perpendicular to the width extension direction of the first connection arm 131.

In some embodiments, the first hinge member 161 and the connection portion of the first motor 121, the second hinge member 162 and the first connection bracket 130, the first connection bracket 130 and the connection portion of the second motor 122, the second connection bracket 140 and the connection portion of the second motor 122, the second connection bracket 140 and the third hinge member 171, the fourth hinge member 172 and the connection portion of the third motor 123, and the carrier structure 150 and the connection portion of the third motor 123 may include an integrated structure. As such, the number of parts may be reduced, which may facilitate assembly and further improve the production efficiency of the handheld gimbal 100.

In some other embodiments, the first hinge member 161 and the connection portion of the first motor 121, the second hinge member 162 and the first connection bracket 130, the first connection bracket 130 and the connection portion of the second motor 122, and the second connection bracket 140 and the connection portion of the second motor 122, the second connection bracket 140 and the third hinge member 171, the fourth hinge member 172 and the connection portion of the third motor 123, and the carrier structure 150 and the connection portion of the third motor 123 may also be formed separately.

In some other embodiments, the first connection bracket 130 and the second connection bracket 140 may be also in another suitable shape, such as a long strip shape. An end of the long strip shape may be connected to the second motor 122 and the other end of the long strip shape may be connected to the third motor 123.

Referring to FIGS. 1, 2, and 5, the handheld gimbal 100 further includes a control assembly 180 arranged at the handle 110 and configured to perform a control function on the handheld gimbal 100 and/or the load 200. In some embodiments, the control assembly 180 includes an operation member 181 and a controller (not shown in the figure). The operation member 181 is arranged at the handle 110 and configured to receive input information. The controller is arranged inside the handle 110 and configured to perform a corresponding operation according to the input information.

The user may input information through the operation member 181. The controller may control the handheld gimbal 100 according to the input information to change the attitude of the load 200. In some embodiments, when using the handheld gimbal 100, the user may input information through the operation member 181 to determine the preset attitude of the payload 200, so that the payload 200 can achieve the preset effect. The operation unit 181 may also perform a control function on the load 200, for example, starting or stopping a photographing and recording function, performing photo page turning, playing videos or photos, etc., which facilitates the user application convenient and improves the user experience.

When the handheld gimbal in the unfolded state shown in FIG. 2 or FIG. 3 needs to be switched to the folded state shown in FIG. 7 or FIG. 8, an external force is applied to cause the first connection bracket 130 to rotate around the first rotation assembly 163 in a direction toward the second plane member 113. Thus, the first connection arm 131 may at least partially abut against the first motor 121, and the second motor 122 may at least partially abut against the second plane member 113. As such, the fourth connection arm 142 may be approximately perpendicular to the first plane member 112 (or the second plane member). The carrier structure 150 and the handle 110 are located on the same side of the fourth connection arm 142. The external force may be further applied to cause the third motor 123 to rotate around the second rotation shaft assembly 173 in a direction close to the first plane member 112. Thus, the carrier structure 150 may at least partially abut against the first plane member 112. The axis of the second motor shaft P and the axis of the third motor shaft R may be approximately parallel. Thus, the handheld gimbal 100 may be in a folded state and the state is locked. The hand-held gimbal 100 may occupy a small space and have a compact structure.

When the handheld gimbal 100 is in a folded state, the third connection arm 141 may at least partially abut against the side of the handle 110. In some embodiments, when the handheld gimbal 100 is in the folded state, the angle between the axis of the second motor shaft P and the axis of the third motor shaft R may also include an acute angle.

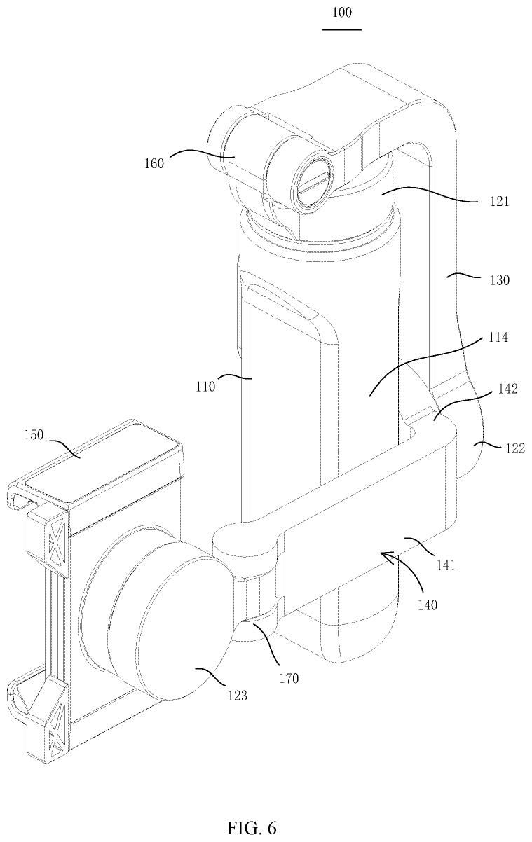

Referring again to FIGS. 5 and 6, in some embodiments, the second hinge structure 170 may be omitted. The first connection arm 131 may rotate around the hinge joint to switch the handheld gimbal 100 from the operation state to the folded state. The second connection arm 132 and the carrier structure 150 are located on two opposite sides of the handle 110, respectively. In some embodiments, referring to FIG. 6, the handle 110 further includes a sidewall 114 connecting the first plane member 112 and the second plane member 113. The second connection arm 132 is located on a side of the second plane member 113 of the handle 110. The carrier structure 150 is located on the side of the sidewall 114 of the handle 110. The carrier structure and the third connection arm 141 are located on the same side of the handle 100.

In the handheld gimbal 100 of embodiments of the present disclosure, the first motor 121 is hinged to the first connection arm 131. When the handheld gimbal 100 is not in use, the first connection arm 131 may be rotated around the hinge joint to switch the handheld gimbal 100 from the operation state to the folded state. The second connection arm 132 and the carrier structure 150 are located on two sides of the handle 110, respectively. Thus, the overall volume of the handheld gimbal 100 may be reduced. The handheld gimbal 100 may occupy a small space, which facilitates the user to storage and carry and improves the user experience.

Referring to FIG. 6, in some embodiments, when the handheld gimbal 100 is in the folded state, the second connection arm 132 at least partially abuts against the handle 110. That is, the second connection arm 132 partially abuts against the second plane member 113 of the handle 110. When the handheld gimbal 110 is in the folded state, the second connection arm 132 may also be arranged at an interval, i.e., spaced apart, from the handle 110. That is, the second connection arm 132 may be arranged at the interval from the second plane member 113 of the handle 110.

In some other embodiments, when the handheld gimbal 100 may be in the folded state, the carrier structure 150 may partially abut against the handle 110 to reduce the space occupied by the handheld gimbal 100 after being folded. In some embodiments, the carrier structure 150 may partially abuts against the sidewall 114 of the handle 110. When the handheld gimbal 100 is in the folded state, the carrier structure 150 and the handle 110 may also be arranged at an interval, i.e., the carrier structure 150 may be spaced apart from the handle 110. That is, the carrier structure 150 and the sidewall 114 of the handle 110 may be arranged at the interval.

The handheld gimbal 100 may be switched between the folded state and the unfolded state. When the handheld gimbal 100 is in the folded state, the handheld gimbal 100 may occupy a small space, has a compact structure, and is convenient for the user to carry. Thus, the portability of the handheld gimbal 100 may be improved.

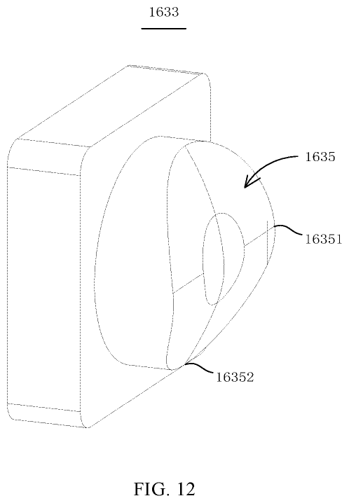

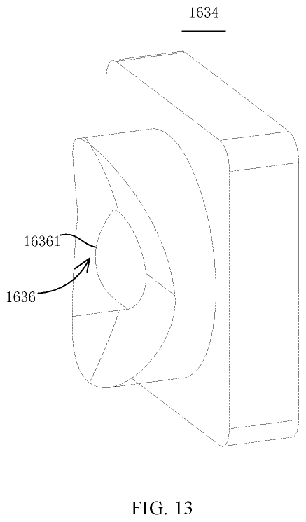

In some embodiments, referring to FIGS. 1 to 14, the handheld gimbal 100 of embodiments of the present disclosure further shows the detail of the structure of the first rotation shaft assembly 163 based on embodiments of the present disclosure.

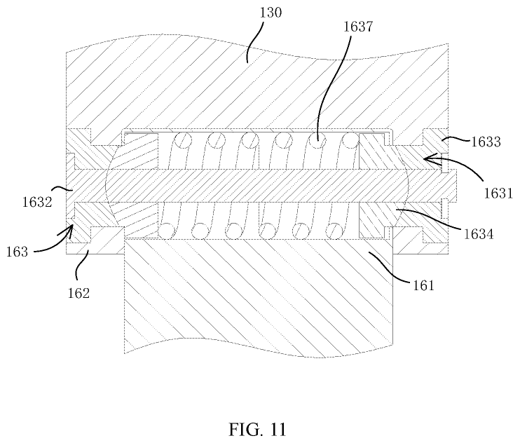

In some embodiments, referring to FIGS. 11 to 14, the first rotation shaft assembly 163 includes a first lock mechanism 1631 and a first rotation shaft 1632. The first lock mechanism 1631 is arranged between the first hinge member 161 and the second hinge member 162. The first lock mechanism 1631 may be configured to lock the relative rotation between the first hinge member 161 and the second hinge member 162, to lock the first connection bracket 130 and the first motor 121 in the unfolded state or the folded state. The first rotation shaft 1632 is arranged through the first lock mechanism 1631 and through at least one of the first hinge member 161 or the second hinge member 162 to hinge the first motor 121 and the first connection bracket 130.

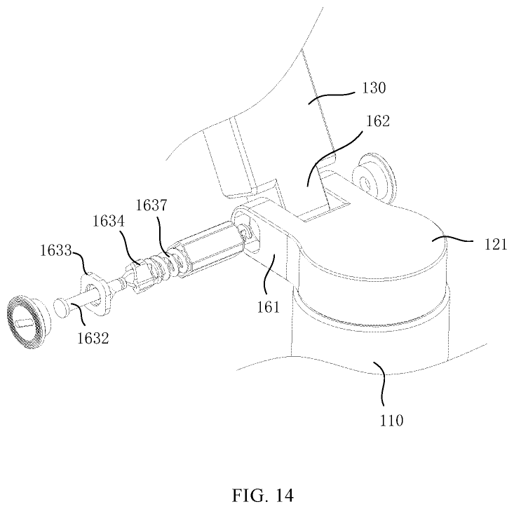

Referring to FIGS. 11 and 14, to lock the first connection bracket 130 in the folded state, in unfolded state, or any certain state of the intermediate states relative to the first motor 121 to improve the reliability of the handheld gimbal 100, a first lock mechanism 1631 is arranged between the first hinge member 161 and the second hinge member 162. The first lock mechanism 1631 may be configured to lock the relative position of the first hinge member 161 and the second hinge member 162 to maintain the handheld gimbal 100 stably in the certain state. When the first lock mechanism 1631 is locked, the first hinge member 161 and the second hinge member 162 cannot rotate relative to each other. When the first lock mechanism 1631 is unlocked, the first hinge member 161 and the second hinge member 162 may rotate relative to each other.

The first lock mechanism 1631 may include any suitable lock structure, as long as the first lock mechanism 1631 can lock the relative rotation between the first connection bracket 130 and the first motor 12. The first lock mechanism 1631, for example, may include at least one of an included plane lock, an eccentric lock, a four-bar mechanism lock, or a snap lock structure.

Referring to FIGS. 11 and 14, the first lock mechanism 1631 includes a first lock member 1633 and a second lock member 1634. The first locking piece 1633 is arranged at the first hinge member 161. The second lock member 1634 is arranged at the second hinge member 162. The second lock member 1634 may cooperate with the first lock member 1633. Thus, the first connection bracket 130 may switch from one of the unfolded state and the folded state to the other one of the unfolded state and the folded state relative to the first motor 121.

Referring to FIGS. 11 to 13, at least one of the first lock member 1633 or the second lock member 1634 includes a protrusion structure 1635. When the first lock member 1633 and the second lock member 1634 rotate relative to each other, the protrusion structure 1635 may increase the distance between the first lock member 1633 and the second lock member 1634. A contact point between the first lock member 1633 and the second lock member 1634 may rotate around the protrusion structure 1635. When the contact point between the first lock member 1633 and the second lock member 1634 is located at the highest point of the protrusion structure 1635, the first connection bracket 130 may be correspondingly in a certain work state. When the contact point between the first lock member 1633 and the second lock member 1634 is located at the lowest point of the protrusion structure 1635, the first connection bracket 130 may be correspondingly in another work state. In some embodiments, the two work states of the first connection bracket 130 may include the folded state and the unfolded state, respectively.

Referring to FIGS. 11 and 14, in some embodiments, the first lock member 1633 includes the protrusion structure 1635. The second lock member 1634 includes a recessed structure 1636 matching the protrusion structure 1635. In some other embodiments, the first lock member 1633 may include the recessed structure 1636, and the second lock member 1634 may include the protrusion structure 1635 that cooperates with the recessed structure 1636. The mutual cooperation of the recessed structure 1636 and the protrusion structure 1635 may realize the cooperation of the first lock member 1633 and the second lock member 1634. When the first connection bracket 130 rotates relative to the first motor 121 through the first hinge structure 160, the second lock member 1634 may rotate around the first rotation shaft 1632.

Referring to FIG. 11 and FIG. 14, the first lock mechanism 1631 further includes a first elastic member 1637. The first elastic member 1637 is arranged in the second lock member 1634. The first elastic member 1637 may be configured to provide an elastic force for the first lock member 1633 and the second lock member 1634. In some embodiments, when the first connection bracket 130 is in the unfolded or folded state, an elastic moment of the first elastic member 1637 may not be equal to zero, which may stably maintain the first connection bracket 130 in the unfolded or folded state and avoid the first connection bracket 130 from shaking. Thus, the reliability and stability of the connection of the first connection bracket 130 may be improved, and the handheld gimbal 100 may be operated reliably in the fold range.

Referring to FIG. 11, in some embodiments, two first lock members 1633 and two second lock members 1634 are included. The two second lock members 1634 abut against two ends of the first elastic member 1637, respectively. As such, the first connection bracket 130 may be further stably maintained in the unfolded state or the folded state to further improve the connection reliability and stability of the first connection bracket 130. In some other embodiments, the numbers of the first lock member 1633 and the second lock member 1634 may be any suitable numbers. For example, the numbers of the first lock member 1633 and the second lock member 1634 may both be one. One end of the first elastic member 1637 may abut against the second lock member 1634, and the other end of the first elastic member 1637 may abut against the second hinge member 162.

Referring to FIGS. 11 to 13, in some embodiments, the protrusion structure 1635 includes two highest protrusion points 16351 and two lowest protrusion points 16352. The recessed structure 1636 includes two lowest recess points 16361. The two highest protrusion points 16351 and the two lowest recess points 16361 form two dead positions of the rotation of the first rotation shaft 1632. In the two dead positions, the recessed structure 1636 and the protrusion structure 1635 may closely cooperated to form the folded state or the unfolded state of the first connection bracket 130. In some embodiments, the line connecting the two highest protrusion points 16351 is approximately perpendicular to the line connecting the two lowest protrusion points 16352.

Referring to FIG. 14, the first lock mechanism 1631 further includes a sleeve (not labeled) sleeved at the first elastic member 1637 and the outside of the first rotation shaft 1632. The first lock mechanism 1631 further includes a clamp piece (not labeled) for clamping and fixing the first rotation shaft 1632 at the first hinge member 161 or the second hinge member 162.

In the handheld gimbal 100, the first connection bracket 130 may rotate relative to the first motor 121 between the unfolded position and the folded position. During the rotation of the first connection bracket 130 from one of the unfolded state and the folded state to the other one of the unfolded state and the folded state, the first lock member 1633 and the second lock member 1634 may rotate relative to each other. Thus, the second lock member 1634 may move along the axial direction of the first rotation shaft 1632 during the movement to compress the first elastic member 1637, cause the first elastic member 1637 to deform elastically, and generate the elastic force. When the first lock member 1633 and the second lock member 1634 rotate a certain angle and reach another cooperation angle, the first lock member 1633 and the second lock member 1634 can closely cooperate to each other under the elastic force of the first elastic member 1637. Thus, the elastic force of the first elastic member 1637 may maintain the first connection bracket 130 in the unfolded or folded state. Therefore, in the handheld gimbal 100, the lock may not need to be operated manually, and only the first connection bracket 130 may need to be rotated between the unfolded state and the folded state to fix the first connection bracket 130.

In some embodiments, the protrusion structure 1635 may include a plurality of protrusions (not shown). The recessed structure 1636 may include a plurality of slots (not shown) that cooperate with the protrusions. The bottom wall of the slot may include an arc-shaped inclined surface. The protrusion may include a cooperation surface (not shown in the figure) that cooperates with the arc-shaped inclined surface. The contact point of the first lock member 1633 and the second lock member 1634 may rotate along the arc-shaped inclined surface or the cooperation surface. When the contact point of the first lock member 1633 and the second lock member 1634 is located at the highest point of the cooperation surface, the first connection bracket 130 may be correspondingly in a certain work state. When the contact point of the first lock member 1633 and the second lock member 1634 is located at the lowest point of the cooperation surface, the first connection bracket 130 may be correspondingly in another work state.

In some embodiments, the plurality of protrusions may be arranged at intervals along a circumferential direction of the first rotation shaft 1632. In some embodiments, the plurality of protrusions may be arranged at equal intervals along the circumferential direction of the first rotation shaft 1632. The number of the protrusions may be set to two, three, four, or more according to actual needs.

The handheld gimbal 100 may be switched between the folded state and the unfolded state. When the handheld gimbal 100 is in the folded state, the handheld gimbal 100 may occupy a small space, has a compact structure, and is convenient for the user to carry, which effectively improves the portability of the handheld gimbal 100. In addition, the first lock mechanism 1631 of the first rotation shaft assembly 163 and the lock mechanism of the second rotation shaft assembly 173 may lock the folded or unfolded state of the handheld gimbal 100 to improve the reliability of the handheld gimbal 100.

In some embodiments, referring to FIGS. 1 to 10 and 15, a structure of a handheld gimbal 100 is approximately the same as the structure of the handheld gimbal 100 of embodiments of the present disclosure. The difference includes that the structure of the first lock mechanism 1631 is different.

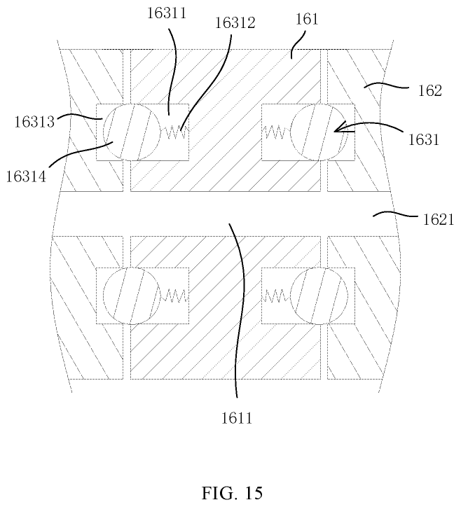

Referring to FIG. 15, the first lock mechanism 1631 includes a first position limit hole 16311, a second elastic member 16312, a second position limit hole 16313, and a positioning member 16314.

In some embodiments, the first position limit hole 16311 is arranged at the first hinge member 161. In some embodiments, the number of the first position limit hole 16311 is two. The two first position limit holes 16311 are symmetrically arranged at the first hinge member 161 along the radial direction of the first rotation shaft 1632. To facilitate processing and improve the operability of the handheld gimbal 100, the size and structure of the two first position limit holes 16311 may be approximately the same.

One end of the second elastic member 16312 abuts against the bottom wall of the first position limit hole 16311. The other end of the second elastic member 16312 abuts against the positioning member 16314. A second position limit hole 16313 is arranged at the position of the second hinge member 162 corresponding to the first position limit hole 16311. The positioning member 16314 may be partially accommodated in the second position limit hole 16313 under the action of the second elastic member 16312. Thus, the relative rotation of the first connection bracket 130 and the first motor 121 may be locked. When the first connection bracket 130 rotates relative to the first motor 121 under an external force, the positioning member 16314 may compress the second elastic member 16312. Thus, the positioning member 16314 may depart from the second position limit hole 16313. Thus, the first connection bracket 130 and the first motor 121 may rotate relative to each other.

The shapes of the second position limit hole 16313 and the positioning member 16314 may include any suitable shapes, as long as the second position limit hole 16313 and the positioning member 16314 may cooperate with each other so that the positioning member 16314 can easily enter or leave the second position limit hole 16313. For example, the shape of the positioning member 16314 may include a spherical shape. The second position limit hole 16313 may include a circular hole that cooperates with the positioning member 16314. The number of the first lock mechanism 1631 may also include any suitable number, for example, one, two, or more. When a plurality of first lock mechanisms 1631 are included, the plurality of first lock mechanisms 1631 may be arranged at intervals along the circumferential direction of the first rotation shaft 1632 to further improve the reliability of the handheld gimbal 100.

The handheld gimbal 100 may be switched between the folded state and the unfolded state. When the handheld gimbal 100 is in the folded state, the handheld gimbal 100 may occupy a small space, has a compact structure, and is convenient for the user to carry to effectively improve the portability of the handheld gimbal 100. In addition, the first lock mechanism 1631 of the first rotation shaft assembly 163 and the lock mechanism of the second rotation shaft assembly 173 can lock the folded or unfolded state of the handheld gimbal 100 to improve the reliability of the handheld gimbal 100.

In the specification of the present disclosure, unless otherwise specified, the terms “mounting,” “connection,” and “coupling” should be interpreted broadly, for example, they may include a fixed connection, a detachable connection, or an integral connection. The connection may further include a mechanical connection, electrical communication, or mutual communication. The connection may further include a connection through an intermediate medium, a communication inside two elements, or an interaction relationship of the two elements. Those of ordinary skill in the art may understand specific meanings of the terms in the present disclosure.

In embodiments of the present disclosure, unless otherwise specified and defined, a first feature being “above” or “below” a second feature may include the direct contact of the first and second features, or may include indirect contact of the first and second features through other feature contacts therebetween. Moreover, the first feature being “above,” “on,” and “over” the second feature includes that the first feature is directly above or obliquely above the second feature, or simply means that the first feature is higher in level than the second feature. The first feature being “below,” “under,” and “beneath” the second feature includes that the first feature is directly under or obliquely under the second feature, or simply means that the first feature is lower in height than the second feature.

The present disclosure provides many various implementations or examples to implement different structures of embodiments of the present disclosure. To simplify embodiments of the present disclosure, components, and settings of specific examples are described above. The description is merely exemplary and does not intend to limit embodiments of the present disclosure. Reference numerals and/or letters are repeated in different examples in embodiments of the present disclosure for simplicity and clarity, and do not indicate relationship among various implementations and/or settings. Embodiments of the present disclosure provide examples of various specific processes and materials, but those of ordinary skill in the art may be aware of application of other processes and/or use of other materials.

In this specification, description with the terms “one embodiment,” “certain embodiments,” “examples,” “specific examples,” or “some embodiments,” etc., means that specific features, structures, materials, or characteristics described in connection with embodiments or examples are included in at least one embodiment or example of the present disclosure. In the present disclosure, the schematic description of the above terms does not necessarily refer to a same embodiment or example. Moreover, the described specific features, structures, materials, or characteristics may be combined in any suitable manner in any one or more embodiments or examples.

Although embodiments of the present disclosure are shown and described above, above-described embodiments are exemplary and should not be considered as a limitation to the present disclosure. Those of ordinary skill in the art can perform change, modification, replacement, and transformation on above-described embodiments. The scope of the invention is defined by the claims and their equivalents.

What is claimed is:

1. A foldable handheld gimbal comprising:
a handle having a rod shape;
a first motor arranged at the handle and configured to drive a load to rotate around a first motor shaft;
a first connection bracket including:
a first connection arm; and
a second connection arm bending and extending from an end of the first connection arm that is away from the handle;
a second motor connected to the second connection arm and configured to drive the load to rotate around a second motor shaft;
a second connection bracket, an end of the second connection bracket being connected to the second motor;
a third motor connected to another end of the second connection bracket and configured to drive the load to rotate around a third motor shaft;
a carrier structure fixedly connected to a rotor of the third motor and configured to carry the load; and
a hinge structure hinged to the first motor and the first connection arm;
wherein:
the first connection arm is configured to rotate around a hinge joint of the hinge structure to switch the handheld gimbal between an operation state and a folded state; and
in response to the handheld gimbal being in the folded state, the second connection arm and the carrier structure are configured to be located on two sides of the handle, respectively.

2. The handheld gimbal of claim 1, wherein when the handheld gimbal is in the folded state, the second connection arm and the carrier structure are located on two opposite sides of the handle, respectively.

3. The handheld gimbal of claim 2, wherein when the handheld gimbal is in the folded state:
the second connection arm partially abuts against or is spaced apart from the handle; or
the carrier structure partially abuts against or is spaced apart from the handle.

4. The handheld gimbal of claim 1,
wherein the hinge structure is a first hinge structure and the hinge joint is a first hinge joint;
the handheld gimbal further comprising:
a second hinge structure hinged to the second connection bracket and the third motor;
the first connection arm and the third motor are configured to rotate around the first hinge joint and a second hinge joint of the second hinge structure, respectively, to switch the handheld gimbal between the operation state and the folded state;
and the second connection arm and the carrier structure are configured to be locate on two opposite sides of the handle, respectively.

5. The handheld gimbal of claim 4, wherein when the handheld gimbal is in the folded state:
an axis of the second motor shaft is approximately parallel to an axis of the third motor shaft; or
an angle between the axis of the second motor shaft and the axis of the third motor shaft is an acute angle.

6. The handheld gimbal of claim 4, wherein the second hinge structure includes:
a first hinge member extending from an end of the second connection bracket that is away from the second motor;
a second hinge member extending outward from an outer periphery of the third motor; and
a rotation shaft assembly connected to the first hinge member and the second hinge member to hinge the second connection bracket and the third motor.

7. The handheld gimbal of claim 6, wherein the second hinge member extends outward from a side periphery of the third motor.

8. The handheld gimbal of claim 7, wherein:
the first hinge member is located at an end of the second rotation shaft assembly, and the second hinge member is located at a middle of the second rotation shaft assembly;
the first hinge member is located at the middle of the second rotation shaft assembly, and the second hinge member is located at an end of the second rotation shaft assembly; or
the first hinge member is located at an end of the second rotation shaft assembly, and the second hinge member is located at another end of the second rotation shaft assembly.

9. The handheld gimbal of claim 1, wherein the hinge structure includes:
a first hinge member extending outward from an outer periphery of the first motor;
a second hinge member extending from the first connection bracket toward the first motor; and
a rotation shaft assembly connected to the first hinge member and the second hinge member, and configured to hinge the first motor and the first connection bracket.

10. The handheld gimbal of claim 9, wherein in response to the handheld gimbal being in the unfolded state, projections of the first motor, the first hinge member, and the second motor at a longitudinal cross section of the handle are arranged in sequence.

11. The handheld gimbal of claim 9, wherein:
the first hinge member is located at an end of the rotation shaft assembly, and the second hinge member is located at a middle of the rotation shaft assembly;
the first hinge member is located at the middle of the rotation shaft assembly, and the second hinge member is located at an end of the rotation shaft assembly; or
the first hinge member is located an end of the rotation shaft assembly, and the second hinge member is located at another end of the rotation shaft assembly.

12. The handheld gimbal of claim 9, wherein the rotation shaft assembly includes:
a lock mechanism arranged between the first hinge member and the second hinge member, and configured to lock a relative rotation between the first hinge member and the second hinge member to lock the first connection bracket in an unfolded state or the folded state; and
a rotation shaft passing through the lock mechanism and at least one of the first hinge member or the second hinge member.

13. The handheld gimbal of claim 12, wherein the lock mechanism includes:
a first lock member arranged at the first hinge member;
a second lock member arranged at the second hinge member and configured to cooperate with the first lock member to cause the first connection bracket to switch between the unfolded state and the folded state relative to the first motor; and
an elastic member arranged in the second lock member and configured to provide an elastic force for the first lock member and the second lock member.

14. The handheld gimbal of claim 12, wherein the lock mechanism includes:
two first position limit holes arranged at the first hinge member or the second hinge member and symmetrically along a radial direction of the rotation shaft;
an elastic member, an end of the elastic member abutting against at least one of the first position limit holes;
a second position limit hole arranged at the second hinge member or the first hinge member; and
a positioning member abutting against another end of the elastic member and partially accommodated in the second position limit hole, and configured to, when the first connection bracket rotates relative to the first motor, compress the elastic member move out of the second position limit hole.

15. The handheld gimbal of claim 1, wherein the handle includes:
a handle body connected to the first motor; and
a first plane member and a second plane member arranged on two opposite sides of the handle body, respectively.

16. The handheld gimbal of claim 15, wherein when the handheld gimbal is in the folded state:
a cross section of the third motor is approximately parallel to the first plane member, or a cross section of the second motor is approximately parallel to the second plane member; or
the carrier structure partially abuts against the first plane member, and/or the second motor partially abuts against the second plane member.

17. The handheld gimbal of claim 1, wherein:
when the handheld gimbal is in the folded state, the first connection arm partially abuts against an end of the first motor;
the first connection arm is approximately perpendicular to the second connection arm;
a length of the first connection arm is smaller than a length of the second connection arm; and
the second connection bracket includes a third connection arm, two ends of the third connection arm being connected to the second motor and the third motor, respectively.

18. The handheld gimbal of claim 17, wherein when the handheld gimbal is in the folded state, the third connection arm partially abuts against a side of the handle.

19. The handheld gimbal of claim 1, wherein the first motor shaft includes a yaw motor shaft, the second motor shaft includes a pitch motor shaft, and a third motor shaft includes a roll motor shaft.

20. The handheld gimbal of claim 1, wherein:
the hinge joint is a first hinge joint;
a rotation angle of the first connection bracket around the first hinge joint is in a range from 135° to 215°; and
a rotation angle of the third motor around a second hinge joint is in a range from 60° to 120°.
